(19) United States
(12) Patent Application Publication
(10) Pub. No.: US 2023/0191844 A1
(43) Pub. Date: Jun. 22, 2023

(54) TRUCK TIRE

(71) Applicant: The Goodyear Tire & Rubber Company, Akron, OH (US)

(72) Inventors: Ettore Passante Spaccapietra, Ettelbruck (LU); Philippe Joseph Auguste Muller, Champlon (BE)

(21) Appl. No.: 18/045,509

(22) Filed: Oct. 11, 2022

Related U.S. Application Data
(60) Provisional application No. 63/265,529, filed on Dec. 16, 2021.

(51) Int. Cl. B60C 9/20

(52) U.S. Cl. CPC B60C 9/20; B60C 2200/06; B60C 2009/2016; B60C 2009/2019; B60C 2009/2035

(57) ABSTRACT

A pneumatic tire for use on trucks, the tire comprising a tread and a belt structure located radially inward of the tread, the belt structure including a pair of working belts, wherein the working belts are reinforced plies each comprising parallel reinforcement elements, wherein the angle of the reinforcement elements in the respective working belt ranges from 12 degrees to 35 degrees from the circumferential direction, wherein the belt structure further includes a low angle belt positioned between the working belts comprising parallel reinforcement elements angled at less than 5 degrees from the circumferential direction, and wherein a first and second narrow belt is positioned on the lateral ends of the low angle belt, and wherein the first and second narrow belt are each positioned radially inward of an axially outermost groove on each side of the tread.

### FIELD OF INVENTION

The invention relates in general to pneumatic tires, and more particularly for vehicles such as trucks.

### BACKGROUND OF THE INVENTION

The commercial truck market is moving towards an increase in overall vehicle weight, which is due in part to the increase in weight of the motor and equipment. The increase in overall vehicle weight requires a tire capable of handling the additional loading. Thus, a tire with improved crown durability and increased load carrying capacity is desired.

### Definitions

“Aspect Ratio” means the ratio of a tire's section height to its section width.

“Axial” and “axially” mean the lines or directions that are parallel to the axis of rotation of the tire.

“Bead” or “Bead Core” mean generally that part of the tire comprising an annular tensile member, the radially inner beads are associated with holding the tire to the rim being wrapped by ply cords and shaped, with or without other reinforcement elements such as flippers, chippers, apexes or fillers, toe guards and chafers.

“Belt Structure” or “Reinforcing Belts” means at least two annular layers or plies of parallel cords, woven or unwoven, underlying the tread, unanchored to the bead.

“Carcass” means a laminate of tire ply material and other tire components cut to length suitable for splicing, or already spliced, into a cylindrical or toroidal shape. Additional components may be added to the carcass prior to its being vulcanized to create the molded tire.

“Circumferential” means lines or directions perpendicular to the axial direction.

“Cord” means one of the reinforcement strands, including fibers, which are used to reinforce the plies.

“Extensible” means a cable, cord, wire or reinforcement having an elongation at 10% of the breaking load greater than 0.2%, when measured from a cord extracted from a cured tire.

“Inner Liner” means the layer or layers of elastomer or other material that form the inside surface of a tubeless tire and that contain the inflating fluid within the tire.

“Ply” means a cord-reinforced layer of elastomer-coated, radially deployed or otherwise parallel cords.

“Radial” and “radially” mean directions radially toward or away from the axis of rotation of the tire.

“Radial Ply Structure” means the one or more carcass plies or which at least one ply has reinforcing cords oriented at an angle of between 65° and 90° with respect to the equatorial plane of the tire.

### BRIEF DESCRIPTION OF THE DRAWINGS

The invention will be described by way of example and with reference to the accompanying drawings in which:

FIG. 1 is a cross-sectional view of a first embodiment of a one half of a tire crown area of the present invention illustrating the belt package; and

FIG. 2 is a schematic of a belt layup trajectory for the zero degree full and folded belt edges.

### DETAILED DESCRIPTION OF THE INVENTION

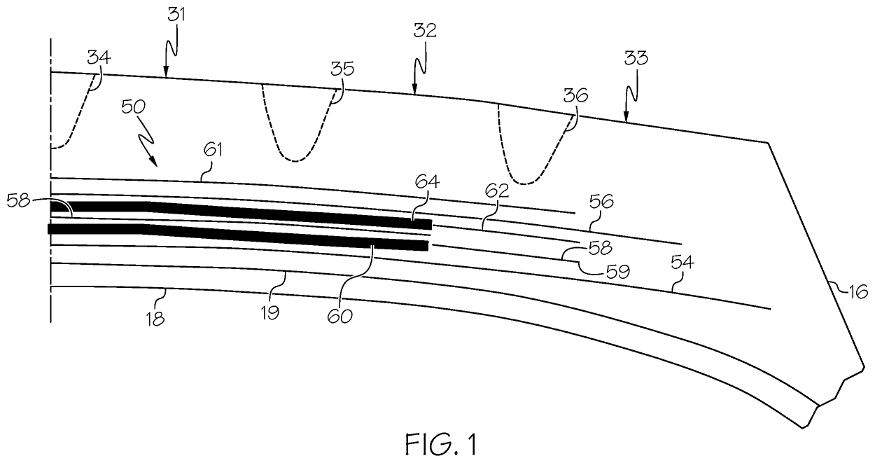

FIG. 1 illustrates a first embodiment of a pneumatic tire, suitable for use as a truck tire. The tire 10 has a tread 12 with a non-skid depth D. The tire tread 12 may comprise a plurality of circumferentially continuous ribs, which may vary, but are shown for example as ribs 31, 32 and 33. Positioned between each rib is a circumferential groove 34, 35, 36, which are preferably continuous. The tread may also comprise optional sipes (not shown). The tread pattern is not limited to same, and may comprise, for example, a plurality of blocks and grooves (not shown).

The tire 10 further comprises a casing which includes two opposed sidewalls 16 which extend down from the tread 12 to the bead area (not shown). The casing of the tire may include an inner liner 18 which is typically formed of halobutyl rubber which forms an air impervious barrier. The tire casing may further include one or more radial plies 19 extending from the tread, down the sidewall to the tire bead and wrapped about or otherwise secured to each annular bead.

The tire 10 further includes a belt package 50 which is located between the tread and the one or more plies 19. The belt package comprises layers of reinforcement. The ply 19 and the belt reinforcing structure 50 are made from cord reinforced elastomeric material, wherein the cords are typically steel wire or polyamide filaments and the elastomer preferably being rubber.

The belt reinforcing structure 50 includes a first working belt 54 that is the radially innermost belt of the belt package 50. The first working belt 54 is located radially inwards of the second working belt 56, and is preferably the widest belt layer of the belt reinforcing structure 50. The first working belt 54 has a width which is preferably equal or, about equal, i.e. ±5%, to the tread arc width. The breaker angle of belt 54 is between 10 and 50 degrees, preferably with a right orientation, more preferably in the range of 19 to 25 degrees. Belt 54 is preferably made of extensible wire, which has a % elongation at 10% of breaking load of greater than 0.2%. The wire may be a hybrid cord or a steel wire.

The second working belt 56 is the second member of the working belt pair. The second working belt 56 has a width less than the width of the first working belt 54, and is preferably radially outward of the first working belt 54. Preferably, the second working belt 56 has a width less than the width of belt 54 by a step off, which may range from 10 to 20 mm. Belt 56 has a breaker angle between 12 and 35 degrees, preferably with a left orientation, more preferably in the range of 19 to 25 degrees. Belt 56 is preferably made of extensible wire, and is the same as the wire of the first working belt 54. More preferably, the wire has the same construction with the same but opposite angular orientation as the wire of belt 54.

The belt structure 50 further comprises a low angle belt 58 which is preferably located between the working pair belts, 54, 56. The low angle belt 58 has reinforcement cords that are oriented circumferentially at 5 degrees or less, preferably 2 degrees or less, more preferably 0 degrees with the tire midcircumferential midplane. The low angle belt 58 has an axial belt width less than the belt width of the working belts 54,56. The low angle belt 58 is layed over a rubber spacer strip 60. The rubber spacer strip 60 has an axial width less than the axial width of the low angle belt 58. Thus, the central portion of the low angle belt 58 is located radially outward of the lateral ends 59 of the low angle belt.

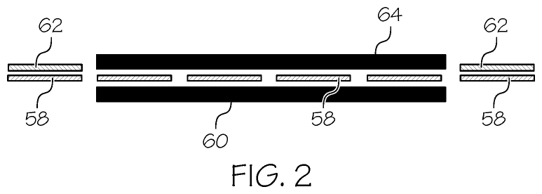

The low angle belt 58 is preferably formed from spirally winding a rubberized strip of one or more cords in a pattern as shown in FIG. 2. Preferably, the strip has 3, 4 or 5 steel cords, and has a width in the range of 5-10 mm, more preferably about 4-6 mm. As shown in FIG. 2, a rubberized strip of reinforcement cords is spirally wound from one end of the belt 58 to the other end of the belt over a rubber spacer 60. Next, a first and second narrow belt 62 is applied on each outer lateral end of the low angle belt 58. Each narrow belt 62 has a narrow axial width and are each positioned radially inward of the axially outermost shoulder groove 36. The narrow belt 62 preferably is the narrowest belt, and has an axial width in the range of two to four times the axial width of the groove. Preferably, the narrow belt 62 has the same angle and orientation as the low angle belt 58. As best shown in FIG. 1, a rubber spacer 64 is preferably located between the split belts 62, and functions to fill the void between the split belts 62.

The low angle belt 58 has a width sized to avoid compression in the shoulder area. The belt width of the low angle belt 58 is preferably in the range of 70% to 80% of the tread arc width, and even more preferably in the range of 73-77%. The low angle belt 58 is preferably wide enough to decrease the strain cycles in the breaker wedge, and is just stopped before the shoulder area to avoid zero degree wire compression and a too round footprint.

The belt structure of the low angle belt 58 may be formed of high tensile steel, and have a % elongation at 10% of breaking load of 0.18 or more, for measurements taken from a cured tire. For measurements taken from bare cords, the % elongation at 10% of breaking load is 0.2 or more. Alternatively, the fourth belt may be formed of non-metal reinforcements such as aramid, carbon fiber, or polyketone or POK.

The belt structure 50 further comprises an optional top belt 61. The top belt has an axial width less than the working belts 54,56.

The aspect ratio of the tire described above may vary. The aspect ratio is preferably in the range of from 0.4 to 0.6. The tire may have a net to gross ratio in the range of 70 to 90, more preferably in the range of 74 to 86, more preferably a 78 to 84.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A pneumatic tire for use on trucks, the tire comprising a tread and a belt structure located radially inward of the tread, the belt structure including a pair of working belts, wherein the working belts are reinforced plies each comprising parallel reinforcement elements, wherein the angle of the reinforcement elements in the respective working belt ranges from 12 degrees to 35 degrees from the circumferential direction, wherein the belt structure further includes a low angle belt positioned between the working belts comprising parallel reinforcement elements angled at less than 5 degrees from the circumferential direction, and wherein a first rubber spacer is located between the low angle belt and the first working belt, wherein the low angle belt has a first and second narrow belt positioned at each lateral end of the low angle belt, and wherein the first and second narrow belt are each positioned radially inward of an axially outermost groove on each side of the tread.

2. The tire of claim 1 wherein the first and second narrow belt have parallel reinforcement elements angled at less than 10 degrees from the circumferential direction.

3. The tire of claim 2 further comprising a second rubber spacer located between the first and second narrow belts.

4. The tire of claim 1 wherein the reinforcement elements are extensible having an elongation at 10% of the breaking load greater than 0.2% when measured at the reinforcement elements extracted from a cured tire, and wherein the extensible reinforcement elements are wires comprising steel or hybrid cords.

5. The tire of claim 1 wherein the axial width of each of the narrow belts is in the range of 1 to 3 inches.

6. The tire of claim 1 wherein the axial width of each of the narrow belts is in the range of 1 to two times the axial width of a groove located radially outward of the narrow belt.

7. The tire of claim 1 wherein the axial width of each of the narrow belts is less than ⅓ of the tread arc width.

8. The tire of claim 1 wherein the extensible reinforcement elements have an elongation at 10% of breaking load greater than 0.4%, when taken from a cured tire.

9. The tire of claim 1 wherein the extensible reinforcement elements have an elongation at 10% of breaking load greater than 0.8% or greater than 1.5%, when taken from a cured tire.

10. The tire of claim 1 wherein the radially inner working belt has a width equal or about equal to the tread arc width.

11. The tire of claim 1 wherein the radially outer working belt has a width less than the radially inner working belt and wherein the radially inner working belt is the widest belt of the belt structure.

12. The tire of claim 1 wherein the belt comprising the parallel reinforcement elements angled at less than 5 degrees from the circumferential direction has a width in the range of from 70 to 80 percent of the tread arc width.

13. The tire of claim 1 further including a transition belt located radially inwards of the working belts.

14. The tire of claim 11 wherein the transition belt comprises parallel reinforcement elements having an angle which ranges from 45 to 70 degrees from the circumferential direction, preferably an angle which ranges from 45 to 70 degrees right.

15. The tire of claim 11 wherein the transition belt has a width of 60 to 80 percent of the tread arc width.

16. The tire of claim 1 wherein the aspect ratio of the tire is less than or equal to 0.6.
